(19) United States
(12) Patent Application Publication
(10) Pub. No.: US 2008/0154800 A1
(43) Pub. Date: Jun. 26, 2008

(54) REPORTING AND BILLING SYSTEM FOR CLEAN ENERGY INFRASTRUCTURE

(76) Inventors: Gene S. Fein, Lenox, MA (US); Edward Merritt, Lenox, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/691,962

(22) Filed: Mar. 27, 2007

Related U.S. Application Data
(63) Continuation-in-part of application No. 11/645,109, filed on Dec. 22, 2006.

(51) Int. Cl. G06F 17/30

(52) U.S. Cl. 705/412

(57) ABSTRACT

Disclosed is a method and system for providing reporting and billing information in an installed energy roadway system. Newer alternative energy gathering systems will need state of the art reporting systems to generate accurate accounting, power distribution, efficiency, maintenance, billing and third party royalty information. The invention method provides at least one energy device connecting to an installed energy roadway system. The energy device may store harnessed energy from alternative energy resources, such as solar, wind, or any combination thereof. The method receives at least one customer's information utilizing the at least one energy device and the information associated with the at least one energy device. The method then processes the information for billing and reporting purposes.

### RELATED APPLICATION

This application is a continuation in part application of U.S. application Ser. No. 11/645,109, entitled “SYSTEM AND METHOD FOR CREATING A NETWORKED INFRASTRUCTURE DISTRIBUTION PLATFORM OF FIXED AND MOBILE SOLAR AND WIND GATHERING DEVICES”, filed on Dec. 22, 2006. The entire teachings of the above application are incorporated herein by reference.

### BACKGROUND OF THE INVENTION

It is well known that wind power turbines can generate power that can be delivered via interconnection to existing grid systems or can be used to power individual homes, businesses and utilities. Most, if not all, wind power systems that are used to gather large amount of power, in the Megawatt range, are large structure wind turbines of at least 100 feet high. In the past, small wind powered turbines usually have been placed at least 15 feet of the ground. Also, most small wind power turbine systems are utilized to power a single home, business or elements of that home or business.

Currently, large wind installations in the order of 100 foot or greater sized turbines dot the landscape of the planet. These turbines are often positioned in remote fields out to sea, or on private property away from public infrastructure. Small wind installations of turbines and other gathering devices in the 5 to 30 foot range are typically utilized in three deployments. The first deployment features clusters of small to mid sized turbines set up in remote windy areas such as the desert environment near Palm Desert, Calif. The second deployment features isolated powering of small homes and businesses such as those in remote arctic or other extreme cold climates where heating and cooling infrastructure do not exist or is augmented at the micro use level for one home or business by small wind turbine implementation. The third deployment model features isolated powering of entities for government utilities, such as the isolated powering of single light stands at the Hanauma Bay National Park public parking lot in Oahu, Hi.

Conventional models address power plant and isolated use models for the generation and distribution of wind power. Large turbines generate Megawatt volumes of power to be utilized locally or interconnected back to the grid system. Small wind generation systems are typically used to solve local power issues, such as street lights or home or business power needs. Small wind generation systems can also be interconnected to a grid system for the purpose of selling the power generated to a public or private utility.

Unfortunately, the existing conventional uses have certain limitations in distribution and deployment. Large turbines have faced environmental and Defense Department concerns. Environmentalists fear that the noise and size of turbines will disrupt both scenic and habitat conditions in addition to threatening the well being of birds that may be caught in the large turbine blades. Department of Defense concerns have been raised over the large turbines interfering with radar signals and tracking. Large turbine systems that are placed far away from existing infrastructure also incur a large expense in the transportation or building of infrastructure to carry the power generated by the turbine system. Finally, the large turbine system represents a major, volatile investment for a single turbine; if the wind is not present or wind currents change then the turbine would be viewed as a poor investment because it will not generate enough power to be profitable. Also, if the turbine breaks for any reason it will produce zero power as it is a large and single entity. Large turbines also require labor intensive maintenance and monitoring. The life cycle for large wind turbines is 20 years and decommissioning the large wind turbine is another environmental issue to contend with.

Small wind power utilized in isolated areas and for private homes, businesses and individual is a great way to introduce clean energy on a unit by unit grass roots level.

The issue with isolated uses which the present invention addresses is that isolated uses are isolated by definition. Isolated uses do not have the ability to directly power businesses or residential sites over a long stretch of land covering tens, hundreds, thousands or hundreds of thousands of miles providing easy access to direct powering of entities as well as multiple grid interconnection points. Also, newer alternative energy gathering systems will need state of the art reporting systems to generate accurate accounting, power distribution, efficiency, maintenance, billing and third party royalty information.

Accordingly, there is a need for an integrated tiny wind turbine power infrastructure that can then easily be connected to multiple direct sources or various grid interconnection points. Components of these very small wind turbines, such as the tiny wiring from turbines forming a tiny wiring grid, with wire turbines on the micrometer scale together, have been shown to have super conductive properties which may help increase the energy gathering efficiency of tiny wind turbines. Further, turbines of various sizes may be made from wind turbines in the 50 micrometer size which are constructed with advanced lithography and laser tools to tiny wind turbines an eighth of an inch long and up that can be made via a standard molding and forming process. Also, the use of tiny wind turbines allows for the deployment of billions of turbines in spaces where larger turbines can not be fit, such as curved guardrails, on top of vehicles and mounted vertically or horizontally in positions that would not be functional for larger turbines.

The functions of the tiny turbines would be wide ranging, from generating heat with their energy by affixing them to winter jackets and gloves to rolling out large strips of installable sheets of tiny turbines for use of public and private highways via median and outside of breakdown lane installations of small wind generating devices would offer numerous advantages. First, private highways and municipalities have existing maintenance crews as well as existing relationships with contracted infrastructure building providers who can be trained to install the wind generation systems along specified parts of roadways. Second, the wind power generation systems can be small and noiseless, small enough to fit millions or billions of tiny turbines on a median between opposite sides of a divided highway with existing median. Third, the energy generated by the devices may be distributed directly to homes or businesses along the highway route. For example, the generated energy could be used to power homes or filling stations along a highway or at a conveniently located hydrogen conversion plant adjacent to the highway or roadway. The filling stations, for example, may use the clean power for the electrolysis of hydrogen. Fourth, other clean energy sources such as solar, geothermal and other heat conversion technologies may be used to create a multi-source clean energy ‘power grid’ along with, or in tandem with, the ‘grid’ in place via potential for the connection of miles of wind power gathering, storage and transfer of generated power.

Fifth, these infrastructures benefit the wind power generator companies; the roadway owners would benefit from lease or easement revenue. A product could benefit from an easily installed ‘skin’ or sheet of the tiny turbine energy gathering material, as well as provide a stable and consistent infrastructure project generating a service provider economy for clean energy production as well as the environment. Sixth, roadways are a consistent source of wind and by having small wind energy capture generating devices close to the ground, such as small noiseless spiral or helix-style turbines, enable the devices to capture wind energy generated by passing vehicles as well as existing currents. Seventh, the power generated by this system may also be connected to a grid system at various convenient points located very close to the existing grid infrastructure.

Finally, there is a need for an installation of a reporting infrastructure that will monitor each key element of the energy gathering system to gather accurate accounting, power distribution, efficiency, maintenance, billing and third party royalty information. Sensors may be used to track individual and grouped components of the system. It will be possible to use video to gauge equipment and personnel function in the field in real time. Reports will be made available online, in real time, with both graphic modeling and text templates used to disseminate information, and such information may be made available in total or sorted to find specific information, or to only make available certain information to specific parties via a tiered password protection system.

### SUMMARY OF THE INVENTION

The present invention relates to a system or method for providing reporting and billing information in an installed energy roadway system. The method provides at least one energy device connecting to a roadway system. The energy device may store energy generating from alternative energy resources, such as solar, wind, or combinations thereof. The method may receive at least one customer's information utilizing the at least one energy device and the information associated with the at least one energy device. The method may then process the information for billing and reporting purposes.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an exemplary schematic of a computer reporting system for an installed energy roadways system in accordance with an embodiment of the present invention;

FIG. 2 is an exemplary flow diagram performed in accordance with an embodiment of the present invention;

FIG. 3 illustrates an exemplary schematic of a computer reporting system for an installed energy roadway system in accordance with another embodiment of the present invention;

FIG. 4 is an exemplary flow diagram performed in accordance with another embodiment of the present invention;

FIG. 5 is an exemplary reporting sheet in accordance with an embodiment of the present invention;

FIG. 6 is a schematic view of a computer environment in which the principles of the preset invention may be implemented; and

FIG. 7 is a block diagram of the internal structure of a computer from the FIG. 6 computer environment.

### DETAILED DESCRIPTION OF THE INVENTION

A description of preferred embodiments of the invention follows.

The present invention, in accordance with one embodiment relates to the creation of a reporting system for an installed clean energy roadway system. The system is made to monitor both mobile gathering devices, such as vehicle installations and their portable batteries, as well as fixed installations such as wind turbines solar panels or sheets and solar wind hybrid combinations.

A “road” (hereinafter also “roadway”) as used herein, is an identifiable route or path between two or more places on which vehicles can drive. A road is typically smoothed, paved, or otherwise prepared to allow easy travel by the vehicles. Also, typically, a road may include one or more lanes, one or more breakdown lanes, one or more medians or center dividers, and one or more guardrails. For example, a road may be highway, turnpike, pike, toll road, state highway, freeway, clearway, expressway, parkway, causeway, throughway, interstate, speedway, autobahn, superhighway, street, railroad, train track, car race track airplane runway and the like.

A “vehicle” as used herein, is any device that is used at least partly for ground-based transportation, for example, of goods and/or humans. For example, a vehicle may be an automobile, a bus, a truck, a tractor, a tank, a motorcycle, a train, an airplane or the like.

Preferably, a vehicle can be an automobile, a bus, a truck, a tank, and a motorcycle. More preferably, a vehicle can be an automobile, a bus, and a truck. Most preferably, a vehicle can be an automobile.

“Wind” as used herein refers to both, wind created by the movement of vehicles (hereinafter also “dirty wind”) and atmospheric wind.

A “wind energy generating device” as used herein, is a device that converts wind energy into electrical energy. Typically, a wind energy generating device can include one or more “wind turbine generators.” A “wind turbine generator” (hereinafter also “wind turbine”) as referred to herein, is a device that includes a turbine and a generator, wherein the turbine gathers or captures wind by conversion of some of the wind energy into rotational energy of the turbine and the generator generates electrical energy from the rotational energy of the turbine. These wind turbine generators can employ a turbine rotating around an axis oriented in any direction. For example, in a “horizontal axis turbine,” the turbine rotates around a horizontal axis, which is oriented, typically, more or less parallel to the ground. Furthermore, in a “vertical axis turbine,” the turbine rotates around a vertical axis, which is oriented, typically, more or less perpendicular to the ground. For example, a vertical axis turbine can be a Darrieus wind turbine, a Giromill-type Darrieus wind turbine, a Savonius wind turbine, a “helix-style turbine” and the like. In a “helix style turbine,” the turbine is helically shaped and rotates around a vertical axis. A Helix-style turbine can have a single-helix design or multi-helix design, for example, double-helix, triple-helix or quad-helix design. The “height” of a wind energy generating device or wind turbine generator as used herein, is the height measured perpendicularly from the ground adjacent to the device or generator to the highest point of the device or generator. Wind energy generating devices can have a height between about a few micrometers and several hundred feet. Wind energy generating devices that employ a plurality, for example, up to millions of small wind turbine generators in one device unit, are also referred to herein as “wind turbine installation sheets”, or “wind turbine installation placards.” Wind energy generation devices can be spatially positioned in any pattern or distribution that conforms with safety and other regulations. Generally the distribution can be optimized in view of the given road and road environment. For example, they can be positioned in a linear equidistant distribution, a linear non-equidistant distribution and a stratum configuration. Wind energy generating devices can optionally include solar energy generating devices as described below.

A “stratum configuration” as used herein, is a distribution of wind energy generation devices, in which the wind energy generation devices that are further away from the nearest lane of a road, are higher. For example, a stratum configuration of wind energy generation devices results from positioning the smallest wind energy generation devices nearest to a road and successively larger wind energy generation devices successively further from the road.

Typically, the average distance between any two closest ground-based wind energy generating devices is in the range between about 5 micrometer and about 200 meters.

Wind energy generating devices can be “vehicle-based,” that is, they are affixed to any part of the surface of a vehicle that allows normal and safe operation of the vehicle. Vehicle-based wind energy generating devices can be permanently affixed or mounted to the car, for example, during the vehicle manufacturing process or overlay bracing, or they can be removably affixed using, for example, one or a combination of snap on clips, adhesive magnetic bonding, a locking screw mounting system, a Thule-type locking devices and the like. A vehicle and a vehicle-based wind energy generating device can also include directional spoilers or wings that are positioned to thereby decrease air resistance of a moving vehicle and increase wind energy generation. A vehicle and a vehicle-based wind energy generating device can also include a device for measuring the direction of the atmospheric wind at or near the positions of one or more vehicle-based wind energy generating devices and movable directional spoilers or wings that are moved based on the measured wind direction information to thereby decrease air resistance of a moving vehicle and increase wind energy generation. Vehicle-based wind energy generating devices can generate energy while a vehicle is parked or moving. Typically, vehicle-based wind energy generating devices have a height of between about a few micrometers and about a few feet.

Any other wind energy generating device that is not affixed to a vehicle is hereinafter referred to as “ground-based.” Typically, a ground-based wind energy generating device can be positioned on part of a road on which its presence does not hinder the flow of traffic or pose a safety risk, near to a road, and on any road object on or near to a road. Examples of road objects are traffic signs, for example, traffic lights, guardrails, buildings and the like. Ground-based wind energy generating devices can be permanently affixed or mounted into the ground multiples of feet deep and sometimes set into a foundation, or they can be affixed such that they are easily removed using, for example, one or a combination of snap on clips, adhesive magnetic bonding, a locking screw mounting system, magnets, braces and ties to metal structures, Thule-type locking devices and the like.

The phrase “near” a road as used herein, refers to the distance of a given ground-based wind energy generating device from a given road that allows the ground-based wind energy generating device to capture wind from passing vehicles (hereinafter also “dirty wind”) to generate energy. This distance can be determined in view of the height of the turbine and the average velocity of an average vehicle passing the wind energy generating device. Typically, this distance can be up to about 40 feet. For example, for a helical axis turbine of 10 feet height, positioned along a road on which vehicle travel with an average velocity of 55 miles per hour, the distance can be up to about 20 feet and for one of 5 feet height, the distance can be up to about 25 feet.

A “wind turbine array” as used herein is a plurality of wind energy generating devices.

A “roadway system electricity grid” as used herein, refers to any network of electrical connections that allows electrical energy to be transported or transmitted. Typically, a roadway system electricity grid can include energy storage systems, systems for inverting energy, single power source changing units, electricity meters and backup power systems.

A “utility grid” (hereinafter also “grid”) as used herein, refers to the existing electrical lines and power boxes, such as Edison and NStar systems.

A “direct power load” is any system that is directly electrically connected to the roadway system electricity grid, i.e. without electrical energy being transmitted via a utility grid, and has a demand for electrical energy, for example, any business or home.

An “energy storage system” as used herein is any device that can store electrical energy. Typically, these systems transform the electrical energy that is to be stored in some other form of energy, for example, chemical and thermal. For example, an energy storage system can be a system that stores hydrogen, which for example, is obtained via hydrogen conversion electrolysis. It can also be any rechargeable battery. “Ground-based energy storage systems” can be positioned below or above the ground. “Vehicle-based energy storage systems” can be permanently affixed or mounted in or on the car, for example, during the vehicle manufacturing process, or they can be removable affixed using, for example, one or a combination of snap on clips, adhesive magnetic bonding, a locking screw mounting system, Thule-type locking device and the like.

The phrase “connected to the roadway system electricity grid” as used herein, refers to any direct or indirect electrical connection of a solar or wind energy generating device to the roadway system electricity grid that allows energy to be transferred from the energy generating device to the grid.

A “solar energy generating device” as used herein, is any device that converts solar energy into electricity. For example, a solar energy generating device can be a single solar or photovoltaic cell, a plurality of interconnected solar cells, (i.e., a “photovoltaic module”), or a linked collection of photovoltaic modules, (i.e., a “photovoltaic array” or “solar panel”). A “solar or photovoltaic cell” (hereinafter also “photovoltaic material”) as used herein, is a device or a bank of devices that use the photovoltaic effect to generate electricity directly from sunlight. For example, a solar or photovoltaic cell can be a silicon wafer solar cell, a thin-film solar cell employing materials such as amorphous silicon, poly-crystalline silicon, micro-crystalline silicon, cadmium telluride, or copper indium selenide/sulfide, photoelectrochemical cells, nanocrystal solar cells and polymer or plastic solar cells. Plastic solar cells are known in the art to be paintable, sprayable or printable roll-to-roll like newspapers.

A “solar energy generating device” can be ground-based or vehicle based. A vehicle-based solar energy generating device can be permanently affixed or mounted to the car, for example, during the vehicle manufacturing process or overlay bracing, or they can be removable affixed using, for example, one or a combination of snap on clips, adhesive magnetic bonding, a locking screw mounting system, Thule-type locking device and the like.

A ground-based solar energy generating device can be attached to any surface that allows collection of solar energy and where its installation does not pose a safety risk or is not permitted by regulations. For example, it can be positioned on part of a road on which its presence does not hinder the flow of traffic or pose a safety risk, near to a road, and on any road object on or near to a road. Examples of road objects are traffic signs, for example, traffic lights, guardrails, buildings and the like. Ground-based wind energy generating devices can be permanently affixed or mounted into the ground multiples of feet deep and sometimes set into a foundation, or they can be affixed such that they are easily removed using, for example, one or a combination of snap on clips, adhesive magnetic bonding, a locking screw mounting system, magnets, braces and ties to metal structures, Thule-type locking device and the like.

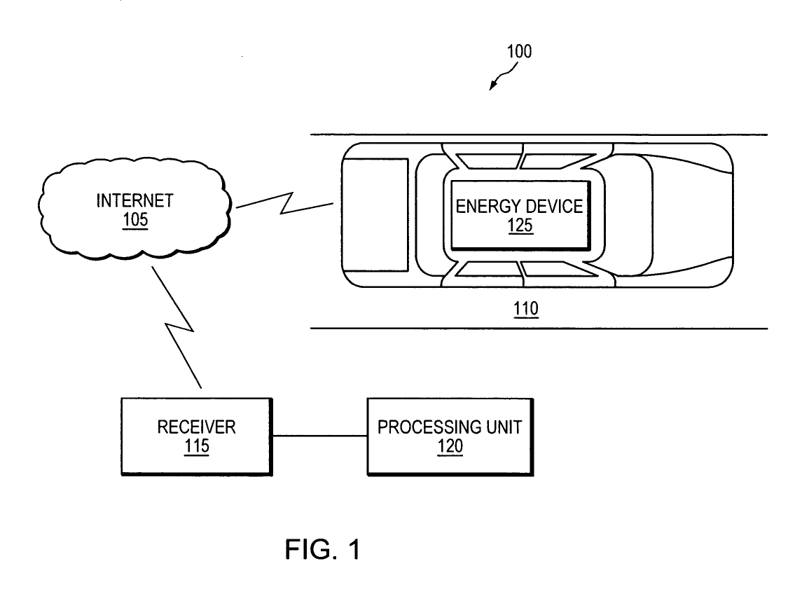

FIG. 1 is a high level diagram of a computer reporting system 100 for an installed energy roadway system electricity grid 110 in accordance with an embodiment of the present invention. A customer may rent an energy device 125 that is electrically connected to the roadway system electricity grid 110. The reporting system 100 includes the roadway system electricity arid 110, a receiver 115, and processing unit 120. The receiver 115 is configured to receive information from the roadway system electricity grid 110 via the Internet 105 (or generally a global computer network). The receiver 115 can be coupled to the Internet 105 through many interfaces including but not limited to a local area network (LAN) or a wide area network (WAN), dial-up connection, cable or SL modems, or special high speed Integrated Services Digital Network (ISDN) lines. The information received by the receiver 115 may be related to the customer and the energy device 125. The energy device 125, for example, may convert energy from solar, wind, or a combination of such sources to electrical energy. The energy device 125 may include rechargeable batteries. The receiver 115 is in communication with the processing unit 120. The processing unit 120 is configured to process at least one customer's information and at least one energy device's information for billing and reporting purposes.

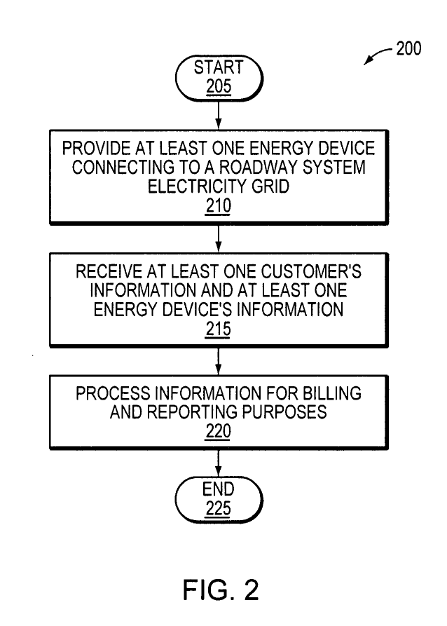

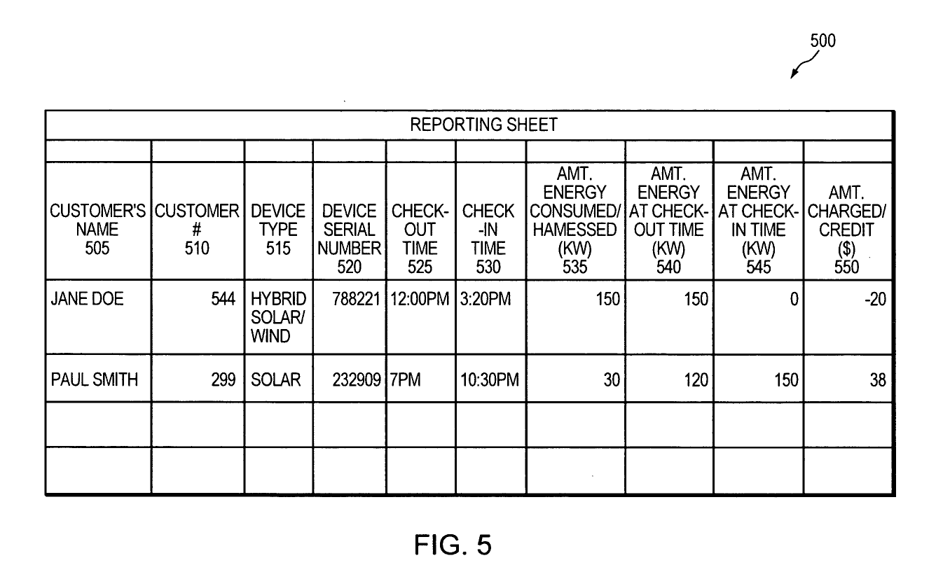

FIG. 2 is a flow diagram showing the process 200 providing reporting and billing information in the energy roadway system electricity grid 110. In this embodiment, the process 200 starts at 205. At step 210, the at least one energy device 125 connect to the roadway system electricity grid 110 is provided. For a given energy device 125 that is checked out, the receiver 115 receives the customer's information and the given energy device's information at step 215. The customer's information may include the customer's name 505, the type of energy devices 515, check-in and check-out time 530, 525 of the at least one energy device 125, and the billing amount 550 as illustrated in FIG. 5. It should be understood that the customer's information is not limited to those discussed above. The processing unit 120 then processes the customer's and the given energy device's information for billing and reporting purposes (step 220). Process 200 then ends at 225.

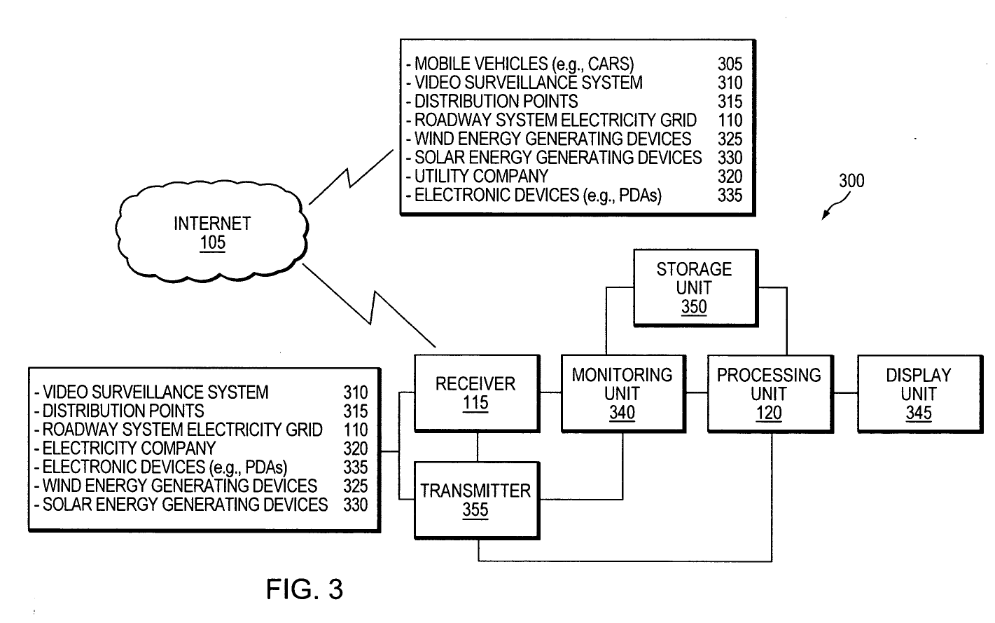

FIG. 3 is a schematic diagram of a computer reporting system 300 for an installed energy roadway system electricity grid 110 in accordance with another embodiment of the present invention. The reporting system 300 includes the receiver 115, processing unit 120, a storage unit 350, a monitoring unit 340, transmitter 355, and display unit 345 connected to various end locations via the global network (e.g., Internet 105). The end locations may also be hard wired to the receiver 115 and/or the transmitter 355. The end locations may be mobile vehicles 305 (e.g. cars), video surveillance systems 310 distribution points 315, roadway system electricity grid 110, utility company 320, electronic devices 335 (e.g. PDAs), wind energy generating devices 325, and solar energy generating devices 330. It should be understood that there may be more end locations as discussed above.

The display unit 345 may display the at least one customer's information and the operating status of the at least one energy device 125. The display unit 345 may include one or more display devices (e.g., CRT LCD, or other known displays) or other output devices (e.g., printer, etc.). The operating status may be if the energy device 125 is operating normally or if it is malfunctioning.

Each solar 330, wind 325 or combination thereof device may be scanned into or otherwise registered with the system 300 along with each battery (not shown) all logged into the system 300 with their own unique (e.g., number) identifier. Each mobile or fixed vehicle, such as an automobile equipped with at least one energy device 125 that registers for the system 300 is also logged into the system 300 with its own unique (e.g., number) identifier. The energy device 125 may be coupled to a mobile vehicle, such as an automobile, thereby making the automobile itself the energy device 125.

Each system installer and service center 315 is logged into the system 300 and assigned their own unique (e.g., number) identifier. Whenever a piece or multiple pieces of subject equipment 125 are deployed on a vehicle, or whenever a battery is installed or removed from the battery storage depot distribution compartment (BSDDC) 315, the system 300 generates time stamps via bar coded or Radio Frequency Identification (RFID) readers. Video surveillance systems 310 located at the BSDCC 315 may also log installation and uninstall activities as well as battery removals and deposits. Time codes generated by the cameras in the video surveillance systems 310 are generation locked to that of the scanners to yield exact time synchronization. Battery levels are registered once respective batteries are deposited back into or removed from the BSDDC 315 and this data is utilized to match to the users of the batteries to generate credits or debits in the system 300.

Information with regard to fixed solar, wind and hybrid solar wind installations as part of the roadway system electricity grid 110 may be gathered by the system 300 to generate reporting information. Sensors, relays and micro-sensors may be installed on each fixed or networked energy gathering element where power flows out of the element. Also, each distribution point 315 in addition to being metered with a standard or totalizing meter may also be equipped with sensors, micro-sensor or relays to gauge the flow of resulting generated electricity. In preferred embodiments, these sensors transfer data wirelessly either to a relay point or directly to a POP Network Operations Center, where the data is then passed securely through to the reporting system 300 infrastructure including database and reporting program software. Video surveillance system 310 may also be utilized with a wireless feed of the video being transferred back to the reporting system 300. This data obtained by the system 300 is utilized to verify energy generated by the roadway system electricity grid 110, to verify the amount of energy being distributed to specific distribution points 315 and to gather key data on the functioning, efficiency and maintenance of the system.

Data obtained by the system 300 in real time may be used to divert power to alternate distribution points 315 to maximize efficiency or to avert a system or distribution problem by sending the power to a distribution source that is currently able or willing to handle the power. The data may be used to switch distribution points 315 via on site maintenance or via built in remote switch. Remote switches effectiveness can be gauged in real time due to the sensors, meters and totalizing meters feeding data to the system in real time. The sensors may be independently powered via battery or via the sensors own solar or wind power mini system, or powered from the combination of self power and having the battery or fuel cell in the sensor recharged from power available via the power gathering or distribution element that the sensor is monitoring.

The information gathered by the system 300 may be parsed and published in different ways by the database and the control program. In one embodiment, there is a master system that makes all data available to a main control program. This program can access any piece of real time or archival data available for the purpose of comparison for system efficiency, maintenance or billing purposes. Efficiency curves are modeled to demonstrate when it is economically viable to replace equipment that is functioning at a lower or reduced capacity compared to available alternatives. System emergency data also is available here, both in video and the data generated by the elements in question. Each service center 315 and each stretch of installed roadway system electricity grid 110 can be segmented to generate efficiency gathering models. Each distribution point 315 may be shown in real time and archived to generate trends over time that can be represented by graphical curves and blocks. Components parts and geographical locations of installed roadway system electricity grid 110 may be compared for efficiency and durability based upon mile markers, zip codes, coded unique number on system elements, time of year, time of day, etc. Service depots 315 and individual customer histories are available here. Power flow and profit from each installation can be modeled here. Billing and receipts for mobile and fixed customers including grid utilities 320 and direct powering of businesses as well as other distribution sources can be found here via menu selection.

This data is also available via cross section to generate bills or payables for customers such as utilities or mobile implementation users. Contractors can monitor using the electronic devices 335 for system defects and data. Maintenance crews can be alerted to problems that need fixing. Fixed installation managers can view the data segments they are responsible for. Mobile installation managers can view the data segments they are responsible for.

Data backups in the storage unit 350 can be archived securely in offsite locations to utilize the data later for comparison, audit, profit maximization or security purposes. Other purposes are also suitable for offsite/off-line processing of this data.

The system 300 may include a transmitter 355 coupled to the receiver 115, monitoring unit 340, and processing unit 120. The transmitter 355 is configured to send a reporting sheet (described further below) and billing information to a variety of end locations (e.g., video surveillance systems 310, distribution points 315, roadway system electricity grid 110, utility companies 320, electronic devices 335 (e.g. PDAs), wind energy generating devices 325, and solar energy generating devices 330). There may be more end locations as discussed above.

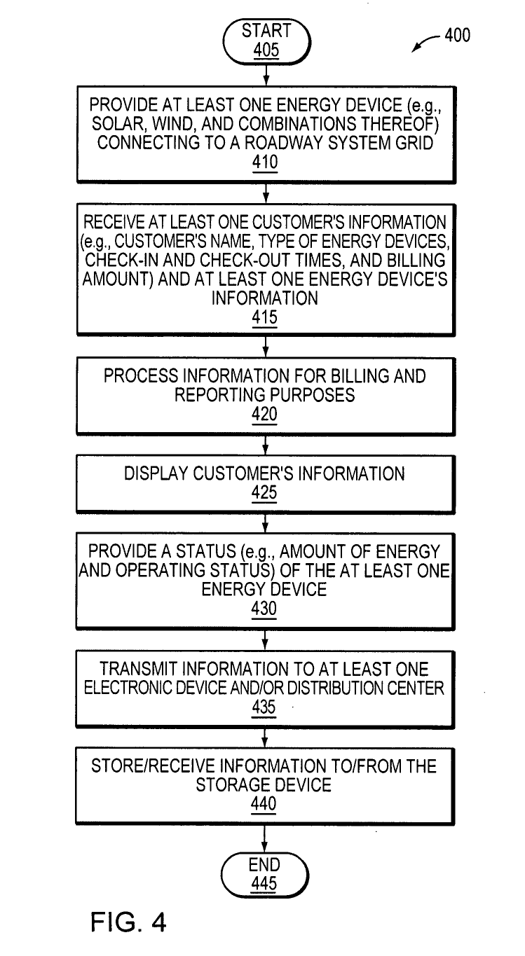

FIG. 4 is a flow diagram showing the process 400 providing reporting and billing information in the energy roadway system electricity grid 110. In this embodiment, the process 400 starts at 405 (e.g. program initialization). The at least one energy device connects to the roadway system electricity grid 110 and is registered with the energy roadway system (410). The receiver 115 receives at least one customer's information and at least one energy device's 125 information associated with the at least one energy device 125 that is checked out by the user (415). The processing unit 120 processes the customer's and at least one energy device's information for billing and reporting purposes (420). The reporting and billing information may include the customer's name 505, type of energy devices 515, check-in and check-out time 530, 525 of the at least one energy device 12D, and billing amount 550. It should be understood that the customer's information may be more than ones discussed above.

The process 400 may display the customer's information (425). The process 400 may also provide a status of the at least one energy device 125 on the display unit 345 (step 425). The status may be, for example, if the energy device 125 is operating normally or if it is malfunctioning (430). The status may also include the amount of stored energy in the at least one energy device 125.

The process 400 may transmit the customer's and the status of the at least one energy device 125 to at least one electronic device 335 and/or distribution centers 315 (step 435). The at least one electronic device 335 may be an IPOD or any device (e.g., network/stand-alone computers, PDAs, WebTV (or other Internet-only) terminals, set-top boxes, cellular/PCS phones, screenphones, pagers, kiosks, blackberries, peer/non-peer systems or technologies or other known (wired or wireless or remote) communication devices receiving personnel respond accordingly.

The process 400 at step 440 may store and receive information to and from the storage unit 350. The storage unit 350 may be any one or more of the known storage devices or systems (e.g., Random Access Memory (RAM), Read Only Memory (ROM), hard disk drive (HDD), floppy drive, zip drive, compact disk-ROM, DVD, bubble memory, data sticks, redundant array of independent disks (RAID), network accessible storage (NAS) systems, storage area network (SAN) systems. Storage unit 350 may store some or all customers and the at least one energy device's information.

Process ends at 445 but may repeat per customer or per energy device 125, or the like,

FIG. 5 is an exemplary reporting sheet (or report) that may be generated by the processing unit 120. The reporting sheet 500 includes indications of customer's name 505, customer identification number 510, device type 515, device serial number 520, device check out and check in times 525, 530, amount of energy consumed or harnessed 535, amount of energy at check out and check in times 540, 545, and amount charged/credit 550. It should be understood that the reporting sheet 500 may have other information than those discussed above.

The reporting sheet 500 may provide information to the customer as to how much energy he or she consumed. For example, Jane Doe rented a hybrid solar and Wind energy device from one of the BSDDCs 315 as indicated in columns 505, 510, 515 and 520 of the first entry in FIG. 5. At the check out time 525 of 12 PM the device had about 150 KW of stored energy. By the time Jane returned the energy device (check-in time 530) at 3:20 PM, there may be 0 KW of energy left in the energy storage device. Thus, the consumed KW 535 is indicated at an amount of 150 KW. As a result, Jane owes $20 to the BSDDC 315 as indicated in column 550. In another example (second entry in FIG. 5), Paul Smith harnessed about 30 KW of energy (e.g., difference of columns 540 and 545) using a solar energy device. Paul will be credited (column 550) $38 when he returns the solar energy device to the BSDDC 315.

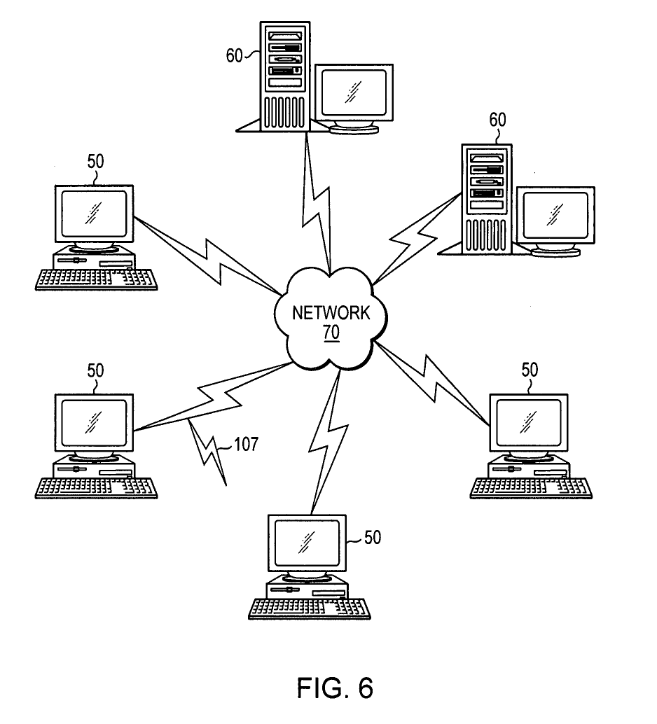

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

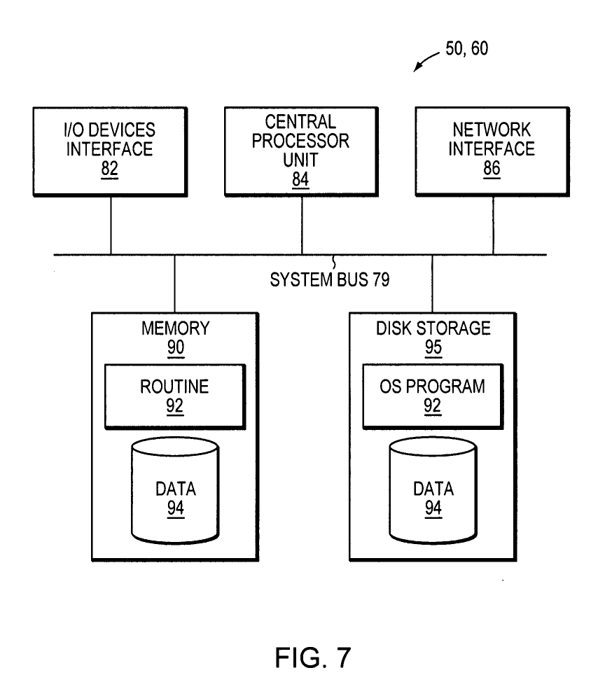

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention. Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

Further, the present invention may be implemented in a variety of computer architectures. The computer network of FIGS. 6 and 7 are for purposes of illustration and not limitation of the present invention.

While this invention has been particularly shown and described with references to preferred embodiments thereof, it will be understood by those skilled in the art that various changes in form and details may be made therein without departing from the scope of the invention encompassed by the appended claims.

It should be understood that there may be more or less customer and energy storage device information as indicated above.

It should be further understood that the flow diagrams of FIGS. 2 and 3 are merely exemplary, and other configurations, arrangements, additional blocks, fewer blocks, and so forth are possible in other embodiments.

It should be further understood, as described above, that the battery storage depot distribution center, system controller, and service center are each example of a distribution point 315. Other distribution points are suitable.

What is claimed is:

1. A computer reporting system for an installed energy roadway system, the computer reporting system comprising:
at least one customer utilizing at least one energy device, the at least one energy device being electrically connected to a roadway system electricity grid;
a receiver configured to receive the at least one customer's information and the at least one energy device's information; and
a processing unit coupled to the receiver, the processing unit configured to process the at least one customer's information and the at least one energy device's information for billing and reporting purposes.

2. The computer reporting system according to claim 1 wherein the at least one customer's information includes customer's name, type of energy devices, check-in and check-out times of the at least one energy device, and billing amount.

3. The computer reporting system according to claim 1 further includes:
a monitoring unit configured to monitor a status of the at least one energy device;
a display unit configured to display the at least one customer's information and status of the at least one energy device;
a storage unit configured to store the at least one customer's information and at least one energy device's information; and
a transmitter configured to send the at least one customer's information and at least one energy device's information to at least one electronic device.

4. The computer reporting system according to claim 3 wherein the at least one electronic device is any type of wireless or non-wireless handheld devices.

5. The computer reporting system according to claim 3 wherein the status of the at least one energy device includes an amount of energy and operating status.

6. The computer reporting system according to claim 3 wherein the receiver and transmitter are configured to send information in a secured manner.

7. The computer reporting system according to claim 1 wherein the at least one energy device includes solar energy device, wind energy device, or any combination thereof.

8. The computer reporting system according to claim 1 wherein the at least one energy device is a mobile vehicle coupled to a solar energy device, wind energy device, or any combination thereof.

9. The computer reporting system according to claim 1 wherein the receiver is configured to receive information about the roadway system electricity grid.

10. The computer reporting system according to claim 1 wherein the roadway system electricity grid includes:
a plurality of ground-based wind energy generating devices; and
one or more roads;
wherein each of substantially all of the ground-based wind energy generating devices is electrically connected to the roadway system electricity grid and positioned on part of one of the roads or near to one or more of the roads to thereby allow energy generation from wind created from passing vehicles in addition to energy generation from atmospheric wind.

11. The computer reporting system according to claim 1 wherein the roadway system electricity grid includes a plurality of ground-based solar energy generating devices, wherein each of substantially all of the ground-based solar energy generating devices, independently, is electrically connected to the roadway system electricity grid and positioned on part of one of the roads or near to one or more of the roads.

12. A computer implemented method for providing reporting and billing information in an installed energy roadway system, the method comprising:
providing at least one energy device connecting to a roadway system electricity grid;
receiving at least one customer's information utilizing the at least one energy device and information associated with the at least one energy device; and
processing the at least one customer s information and the at least one energy device's information for billing and reporting purposes.

13. The computer implemented method according to claim 12 wherein receiving at least one customer's information includes receiving customer's name, type of energy devices, check-in and check-out times of the at least one energy device, and billing amount.

14. The computer implemented method according to claim 12 further includes:
providing a status of the at least one energy device;
displaying the at least one customer's information and status of the at least one energy device;
storing and receiving the at least one customer's information and at least one energy device's information; and
transmitting the at least one customer's information and at least one energy device's information to at least one electronic device.

15. The computer implemented method according to claim 14 wherein providing the status of the at least one energy device includes providing an amount of energy and operating status.

16. The computer implemented method according to claim 14 wherein receiving and transmitting information are in a secured manner.

17. The computer implemented method according to claim 12 wherein providing the at least one energy device includes providing a solar energy device, wind energy device, or any combination thereof.

18. The computer implemented method according to claim 12 wherein providing the at least one energy device is providing a mobile vehicle coupled to a solar energy device, wind energy device, or any combination thereof.

19. The computer implemented method according to claim 12 further includes receiving information about the roadway system electricity grid.

20. The computer implemented method according to claim 19 wherein receiving information about the roadway system electricity grid includes generating energy from wind created from passing vehicles using a plurality of ground-based wind energy generation devices, wherein each of substantially all of the ground-based wind energy generating devices is electrically connected to a roadway system electricity grid and positioned on part of a road or near to one or more roads.

21. The computer implemented method according to claim 19 wherein receiving information about the roadway system electricity grid includes generating energy from solar generating devices, wherein each of substantially all of the ground-based solar energy generating devices, independently, is electrically connected to the roadway system electricity grid and positioned on part of one of the roads or near to one or more of the roads.

22. A computer program product for providing reporting and billing information in an installed energy roadway system, comprising:
a computer useable medium having a computer readable program, wherein the computer readable program when executed on a computer causes the computer to:
receive at least one customer's information utilizing the at least one energy device and information associated with the at least one energy device;
process the at least one customer's information and the at least one energy device's information for billing and reporting purposes;
display the at least one customer's information and a status of the at least one energy device;
store the at least one customer's information and at least one energy device's information; and
transmit the at least one customer's information and at least one energy device's information to at least one electronic device.

23. The computer program product of claim 22, wherein the computer useable medium is any of a CD-ROM, floppy disk, tape, flash memory, system memory, and hard drive.
